(19) United States
(12) Patent Application Publication
(10) Pub. No.: US 2019/0126666 A1
(43) Pub. Date: May 2, 2019

(54) WILDLIFE TROPHY MOUNTING SYSTEM AND METHOD OF USE

(71) Applicant: Garrett Huffines, Dallas, TX (US)

(72) Inventor: Garrett Huffines, Dallas, TX (US)

(21) Appl. No.: 16/174,812

(22) Filed: Oct. 30, 2018

Related U.S. Application Data
(60) Provisional application No. 62/578,766, filed on Oct. 30, 2017.

(51) Int. Cl. B44C 5/02

(52) U.S. Cl. CPC B44C 5/02

(57) ABSTRACT

A cover for secure around a neck portion of a wildlife trophy mount, the cover includes a body; an opening through the body through which the neck portion is received; a seam extending a width of the body and to open and close the body; and a connector to secure the seam in a close position, thereby securing the cover around the neck portion of the wildlife trophy mount in a hidden position.

### BACKGROUND

### 1. Field of the Invention

The present invention relates generally to wildlife trophy mounts, and more specifically, to a wildlife trophy mounting system for improving and/or altering the aesthetical appearance of the mount.

### 2. Description of Related Art

Wildlife trophy mounts are well known in the art and are effective means to display a wildlife trophy. For example, FIG. 1 depicts a conventional wildlife trophy mount 101 having a wildlife trophy 103 secured to a display mount 105. It should be appreciated that many wildlife trophies are mounted directly to a wall, as opposed to a mounting plate, however, these systems suffer the same disadvantages.

One of the problems commonly associated with system 101 is limited customization and aesthetical alteration. For example, it is common for users to desire to add decorative features, such as clothing, to the mount, however, adding items such as clothing is difficult due to the inaccurate fit of the clothing. It should be understood that an article of clothing cannot be easily fit over antlers, therefore adding clothing to wildlife mounts is either impossible or results in an extremely ill-fitting garment.

Accordingly, although great strides have been made in the area of wildlife mounting systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a front view of a common wildlife mount;

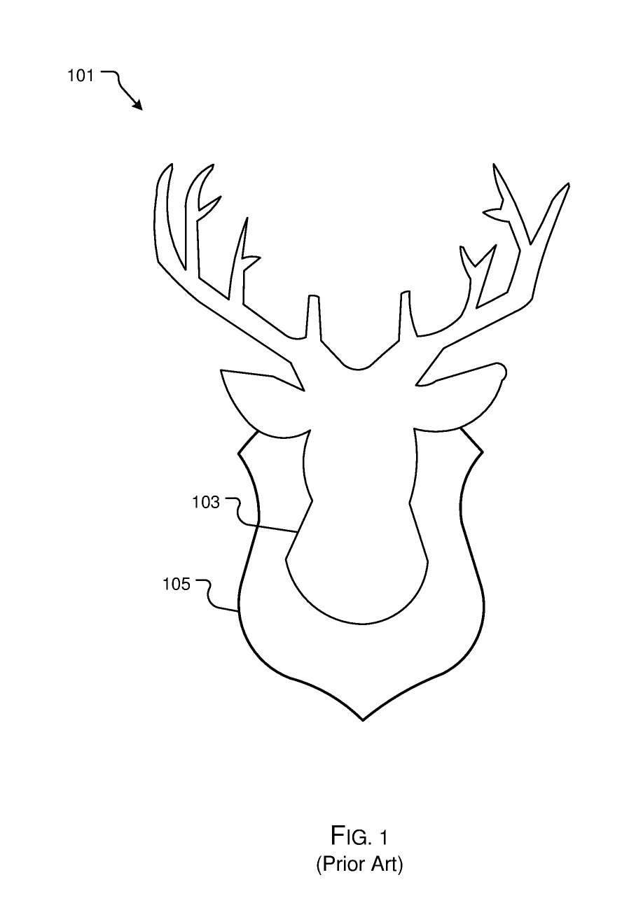

FIG. 2 is a front view of a wildlife trophy mounting system in accordance with a preferred embodiment of the present application;

FIG. 3 is a top view of a cover from FIG. 2; and

FIG. 4 is a flowchart of the method of use of the system of FIG. 2.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional wildlife trophy mounts. Specifically, the present invention provides a means to add well fitted aesthetical features to a wildlife trophy. This feature is accomplished through an attachment system allowing for an opening through a body of clothing, thereby eliminating the need to fit the item over antlers and the like. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

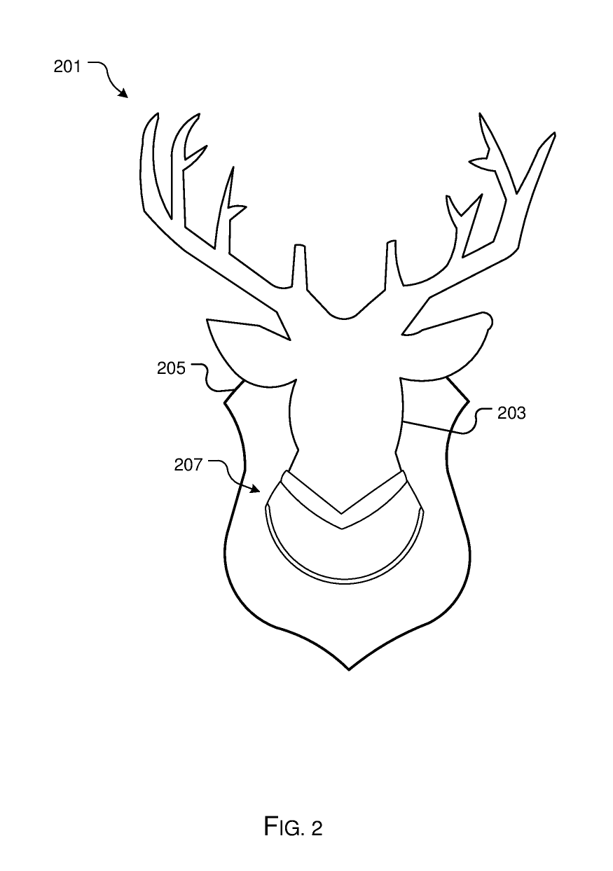

Referring now to the drawings wherein like reference characters identify corresponding or similar elements throughout the several views, FIG. 2 depicts a front view of a wildlife trophy mounting system 201 in accordance with a preferred embodiment of the present application. It will be appreciated that system 201 overcomes one or more of the above-listed problems commonly associated with conventional wildlife mounts.

In the contemplated embodiment, system 201 includes a wildlife trophy 203 secured to a front surface of a display mount 205 configured to secure to a wall (not shown). It should be appreciated that although trophy 203 is shown as a deer, the trophy could be any wildlife. System 201 further includes a cover 207 configured to secure around a neck and/or shoulder portion of trophy 203. It should be appreciated that cover 207 is shaped and sized appropriately to fit snuggly around the neck and/or shoulder portion, while eliminating the need for the cover to fit over antlers.

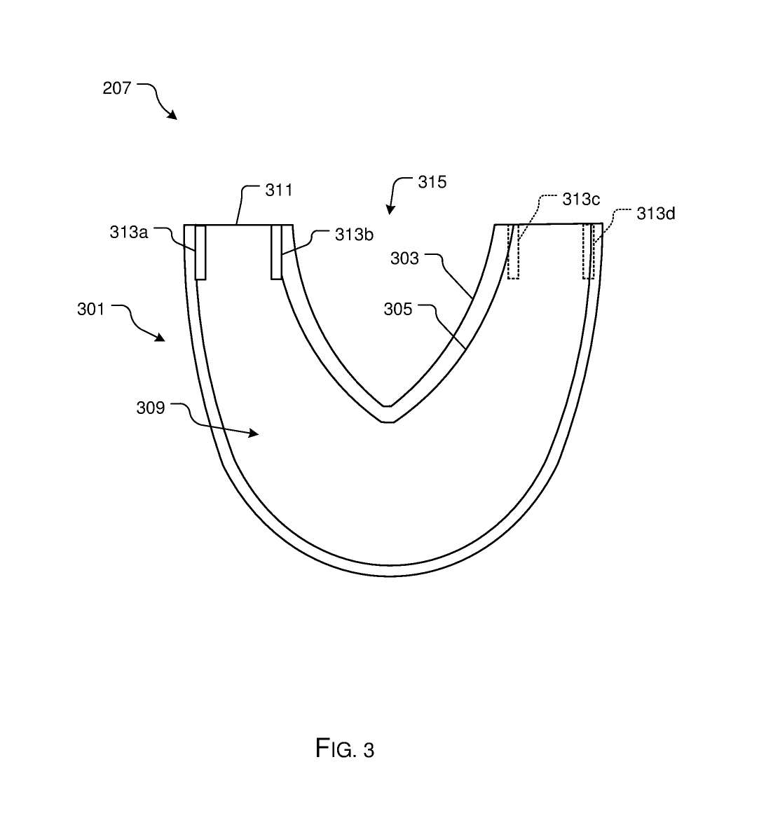

In FIG. 3 a top view of cover 207 is shown. Cover 207 includes a body 301 having a neck band 303 and a chest portion 305. In one embodiment, neck band 303 and chest portion 305 are composed of different materials. It should be appreciated that the body can be configured to appear as a variety of clothing items, including a sporting jersey, a t-shirt, a collared shirt, a coat, a costume, or a plurality of other types of clothing based on the user's preferences. In one embodiment, body 301 includes a front surface 309 and a back surface (not shown), wherein the front surface 309 and back surface have different visual appearances, thereby making cover 207 reversible.

In the preferred embodiment, cover 207 includes a seam 311 configured to be opened and closed via one of more connectors 313a-d and an opening 315 through which the neck/shoulder portion of the trophy is received. It should be appreciated that the connectors allow for the seam to open and close to receive the trophy therebetween. In addition, it should be understood that this feature is necessary to allow the cover to fit over and around antlers. Without such connectors, the cover would either have to include an excessively large opening to fit over antlers, or it would be impossible to add the cover to a mount.

In the present application, it is contemplated that the connectors 313a-b can provide an adjustment means and can be hook and loop fasteners, snaps, buttons, clips, zippers, or any other device appropriate to open and close the seam and hold the two sides together.

It should be appreciated that one of the unique features believed characteristic of the present application is the configuration of the cover for use around a neck/chest portion of a trophy. This feature is achieved via the plurality of connectors and the adjustability of the connectors, which is necessary to allow the cover to fit around a wildlife mount having antlers and be placed on the mount's shoulder/chest area. It should further be appreciated that the adjustability of the connectors allows for the cover to be properly fitted to variously sized mounts. It should be appreciated that in the preferred embodiments, the connectors are placed in a location to secure behind a head of the wildlife trophy, thereby hiding the connectors from view improving the appearance of the system.

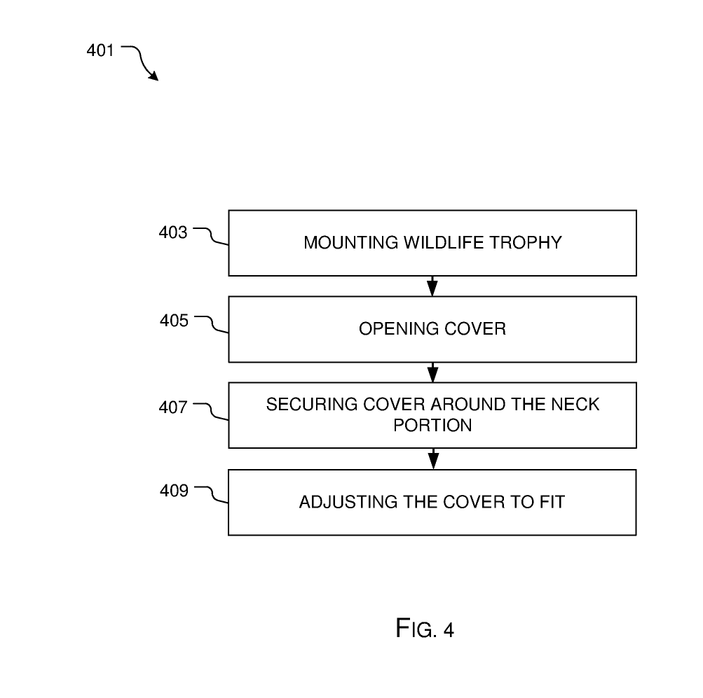

In FIG. 4 a flowchart 401 depicts the method of use of system 201. During use, the wildlife trophy is mounted on the mount and secured to the wall, as shown with box 403. The cover is opened and placed around the neck/shoulder portion of the trophy, as shown with boxes 405, 407. The fit of the cover is then adjusted via the connectors, as shown with box 409.

It should be appreciated that the materials and size of the cover can vary as aesthetical, functional, or manufacturing considerations require.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A wildlife trophy mounting system, comprising:
a display mounting plate adapted for securing to a wall;
a wildlife trophy secured to a front surface of the display mounting plate; and
a cover configured to secure around a neck portion of the wildlife trophy, the cover having:
an opening through which the neck portion is received;
a seam extending a width of the cover and configured to open and close the cover; and
a connector configured to secure the seam in a close position hidden from view.

2. The system of claim 1, wherein the connector is a hook and loop fastener.

3. The system of claim 1, wherein the connector is adjustable.

4. The system of claim 1, wherein the connector is a plurality of snaps.

5. A cover to secure around a neck portion of a wildlife trophy mount, the cover comprising:
a body;
an opening through the body through which the neck portion is received;
a seam extending a width of the body and configured to open and close the body; and
a connector configured to secure the seam in a close position hidden from view, thereby securing the cover around the neck portion of the wildlife trophy mount.

6. The cover of claim 5, wherein the body further comprises:
a front surface; and
a back surface;
wherein the front surface and the back surface are different, thereby allowing for the cover to be reversible.

7. The cover of claim 5, wherein the connector is adjustable.

8. The cover of claim 5, wherein the connector is a hook and loop fastener.

9. The cover of claim 5, wherein the connector is a plurality of snaps.

10. The cover of claim 5, wherein the body further comprises:
a neck band composed of a first material; and
a chest portion composed of a second material.

11. A method of decorating a wildlife trophy mount, comprising:
providing the cover of claim 5;
securing a wildlife trophy to a display mounting plate;
opening the cover;
placing the cover around the neck portion of the wildlife trophy; and
securing the cover in place via the seam and the connector.

12. The method of claim 11, wherein the connector is adjustable.

13. The method of claim 11, wherein the connector is a hook and loop fastener.
